(19) United States
(12) Patent Application Publication
(10) Pub. No.: US 2025/0046283 A1
(43) Pub. Date: Feb. 6, 2025

(54) ELECTRONIC PERCUSSION INSTRUMENT, HIT DETECTION METHOD AND MANUFACTURING METHOD OF ELECTRONIC PERCUSSION INSTRUMENT

(71) Applicant: Roland Corporation, Shizuoka (JP)

(72) Inventor: Kiyoshi Yoshino, Shizuoka (JP)

(73) Assignee: Roland Corporation, Shizuoka (JP)

(21) Appl. No.: 18/719,254

(22) PCT Filed: Dec. 16, 2021
(86) PCT No.: PCT/JP2021/046630

§ 371 Date: Jun. 12, 2024

(51) Int. Cl. G10H 3/14; G10H 1/32

(52) U.S. Cl. CPC G10H 3/146; G10H 1/32; G10H 2220/525

(57) ABSTRACT

An electronic percussion instrument and a hit detection method are provided. Partition parts partition a film part into a plurality of hitting surfaces. A hit sensor is provided on the inner periphery side of each of the plurality of partition parts, and therefore the vibration of a hit against each of the hitting surfaces partitioned by the partition parts can be detected by the hit sensor. Consequently, for example, by generating musical tones of different timbres according to the hit hitting surfaces, various performances become possible compared with when the number of hitting surfaces is one as in the prior art.

### TECHNICAL FIELD

The present invention relates to an electronic percussion instrument and a hit detection method, and more particularly to an electronic percussion instrument capable of various performances and a hit detection method.

### RELATED ART

There is known technology for forming the hitting surface of an electronic percussion instrument by a drumhead that includes a film part that serves as the hitting surface against which the player hits, and a frame part that is connected to an outer edge of the film part. In this type of electronic percussion instrument, as described in, for example, Patent Document 1, a hitting surface is generally formed by applying tension to a film part that covers a cylindrical body part.

### PRIOR-ART DOCUMENT

### Patent Document

Patent Document 1: Japanese Patent Laid-open No. 2019-148623 A (for example, paragraph 0027, FIGS. 1 and 2)

### SUMMARY OF INVENTION

### Problems to be Solved by the Invention

However, in the above-mentioned conventional technology, a single hitting surface is formed by the film part, and therefore there is a problem in that it is incapable of various performances.

The present invention has been made to solve the above-mentioned problems, and has as its object to provide an electronic percussion instrument capable of various performances, and a hit detection method.

### Means for Solving the Problems

In order to achieve the object, the electronic percussion instrument of the present invention includes a body part; a film part covering an upper surface side of the body part; a tension applying part applying tension to the film part; a partition part contacting a lower surface of the film part to which tension is applied by the tension applying part and partitioning the film part into a plurality of hitting surfaces; and a plurality of hit sensors detecting a hit against each of the plurality of hitting surfaces formed by the partition part.

The hit detection method of the present invention is one of hitting an electronic percussion instrument including a body part; a film part covering an upper surface side of the body part; a tension applying part for applying tension to the film part; and a partition part contacting a lower surface of the film part to which tension is applied by the tension applying part and partitioning the film part into a plurality of hitting surfaces. A plurality of hit sensors detect a hit against each of the plurality of hitting surfaces formed by the partition parts.

### BRIEF DESCRIPTION OF DRAWINGS

In FIG. 1, (a) is an exploded perspective view of an electronic percussion instrument according to a first embodiment, and (b) is a top view of the electronic percussion instrument.

FIG. 2 is a partially enlarged cross-sectional view of II-II in FIG. 1(b).

FIG. 3 is an exploded perspective view of an electronic percussion instrument according to a second embodiment.

FIG. 4 is a partially enlarged cross-sectional view of the electronic percussion instrument taken along line IV-IV in FIG. 3.

In FIG. 5, (a) is an exploded perspective view of an electronic percussion instrument according to a third embodiment, and (b) is a top view of the electronic percussion instrument.

FIG. 6 is a cross-sectional view of the electronic percussion instrument taken along line VI-VI in FIG. 5(b).

### EMBODIMENTS OF INVENTION

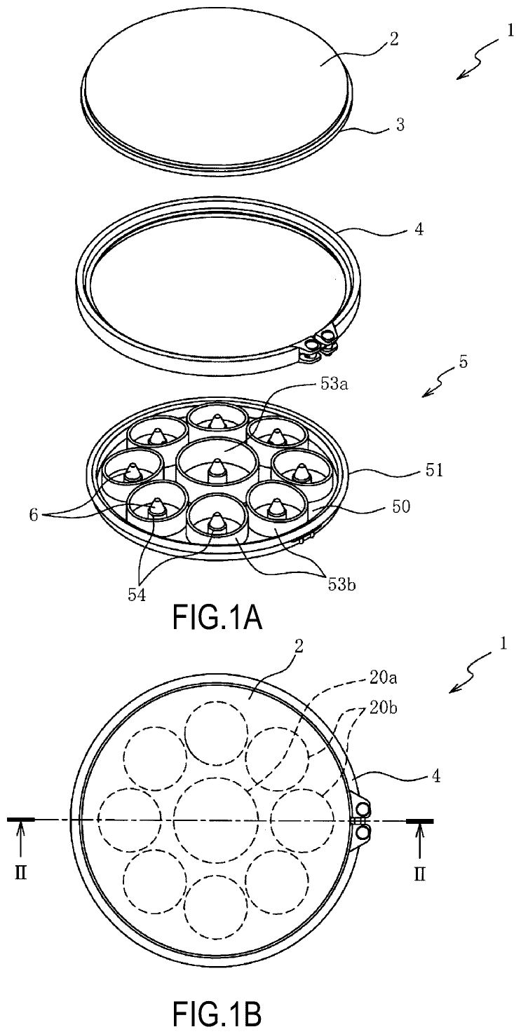

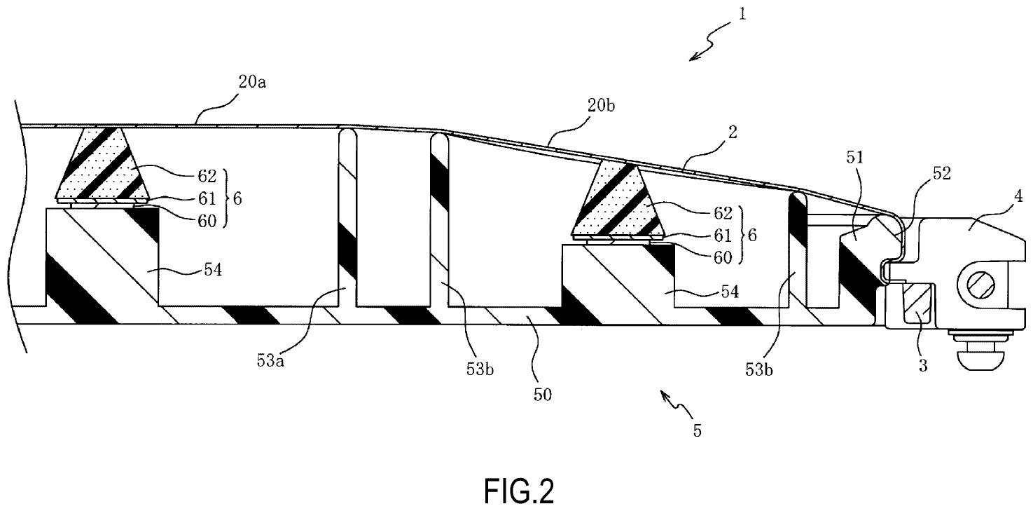

Preferred embodiments will now be described with reference to the accompanying drawings. First, an electronic percussion instrument 1 according to a first embodiment will be described with reference to FIGS. 1 and 2. FIG. 1(a) is an exploded perspective view of the electronic percussion instrument 1 according to a first embodiment, and FIG. 1(b) is a top view of the electronic percussion instrument 1. FIG. 2 is a partially enlarged cross-sectional view of the electronic percussion instrument 1 taken along line II-II in FIG. 1(b). Moreover, in FIG. 1(b), the regions of hitting surfaces 20a, 20b divided by partition parts 53a, 53b are indicated by dashed lines.

As shown in FIGS. 1 and 2, the electronic percussion instrument 1 includes a disk-shaped film part 2. An upper surface of the film part 2 serves as the hitting surfaces 20a, 20b that are hit by the player. The film part 2 is formed in a disk shape using a mesh woven from synthetic fibers, and a circular frame part 3 is fixed to an outer edge of the film part 2.

The frame part 3 is formed using a resin material, and the film part 2 and the frame part 3 are integrally formed by die molding. Moreover, a configuration may also be adopted in which the frame part 3 is formed using a material other than resin (for example, metal or wood), and the frame part 3 is joined to the film part 2 by adhesive or the like.

The frame part 3 is fixed to a body part 5 of the electronic percussion instrument 1 by a tension ring 4. The tension ring 4 is formed in a C-shape, and a spacing of the split part may be expanded or contracted by a bolt. Moreover, the tension ring 4 may adopt a known configuration, so detailed description will be omitted. An example of a known configuration is a tension ring 50 described in Japanese Patent Laid-open No. JP 2020-106592 A.

The body part 5 includes a disk-shaped bottom part 50 and a circular (cylindrical) wall part 51 rising upward from an outer edge of the bottom part 50. The wall part 51 is formed with a convex part 52 (see FIG. 2) for hooking the film part 2 and the frame part 3.

The convex part 52 is an annular protrusion that protrudes outward in the radial direction from an outer peripheral surface of the wall part 51, and with the frame part 3 disposed below the convex part 52 (with the film part 2 wrapped around the convex part 52), the frame part 3 is tightened by the tension ring 4. Since the resin frame part 3 has a predetermined elasticity, the diameter of the frame part 3 is reduced by the tightening of the tension ring 4 (the frame part 3 is pulled toward the inner periphery side), and tension is applied to the film part 2.

When tension is applied to the film part 2, the plurality of partition parts 53a, 53b rising upward from the bottom part 50 of the body part 5 are in contact with the film part 2. Thus, the plurality of hitting surfaces 20a, 20b divided by the partition parts 53a, 53b are formed in the film part 2.

A columnar support part 54 protrudes from the bottom part 50 of the body part 5 on the inner periphery side of each of the partition parts 53a, 53b, and a hit sensor 6 is fixed to the support part 54. The hit sensor 6 includes a disk-shaped double-sided tape 60 (see FIG. 2) that is adhered to an upper surface of the support part 54, and the double-sided tape 60 has cushioning properties. A sensor 61, which is a disk-shaped piezoelectric element, is adhered to an upper surface of the double-sided tape 60, and a truncated cone-shaped cushion 62 is adhered to an upper surface of the sensor 61. The cushion 62 is made of sponge.

When the cushion 62 comes into contact with a lower surface of the film part 2, such that vibration generated when hitting the hitting surfaces 20a, 20b of the film part 2 are transmitted to the sensor 61 via the cushion 62. The result of detection of the hit by the sensor 61 (hit sensor 6) is output to a sound source (not shown), and a musical tone signal based on the result of detection is generated by the sound source. An electronic sound based on a musical tone signal generated by a sound source is output to an amplifier or a speaker (both not shown), and an electronic musical tone corresponding to the musical tone signal is emitted from the amplifier or the speaker.

The hit sensor 6 is provided on the inner periphery side of each of the plurality of partition parts 53a, 53b, such that vibration of a hit against each of the hitting surfaces 20a, 20b partitioned by the partition parts 53a, 53b may be detected by the hit sensor 6. Consequently, by generating musical tones of different timbres according to the hitting surfaces 20a, 20b, for example, various performances become possible compared to the conventional case where there is only one hitting surface.

Moreover, since an upper end part of each of the plurality of partition parts 53a, 53b is covered with a single film part 2, for example, compared to a case in which each of the partition parts 53a, 53b is covered with a plurality of film parts 2, the plurality of hitting surfaces 20a, 20b may be formed with a simple configuration.

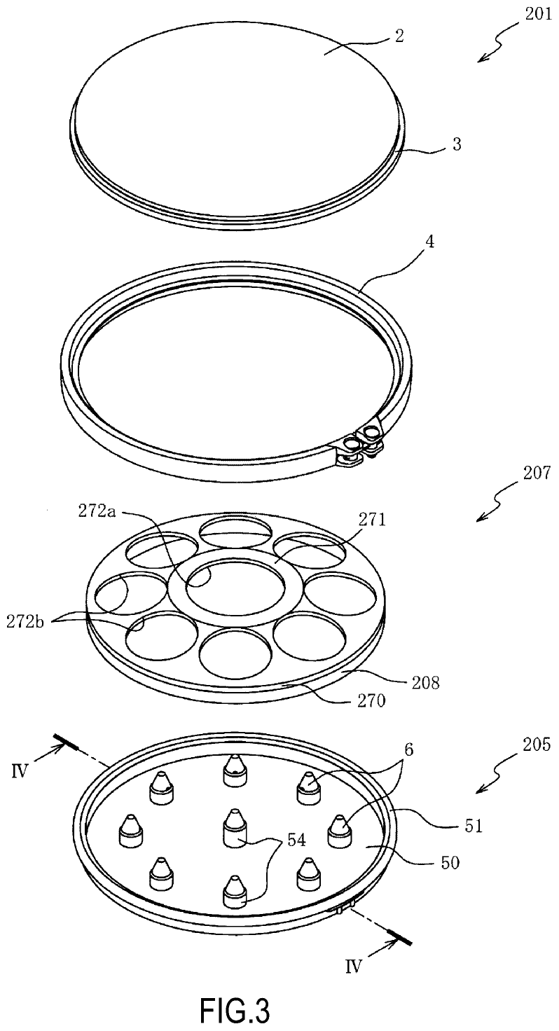

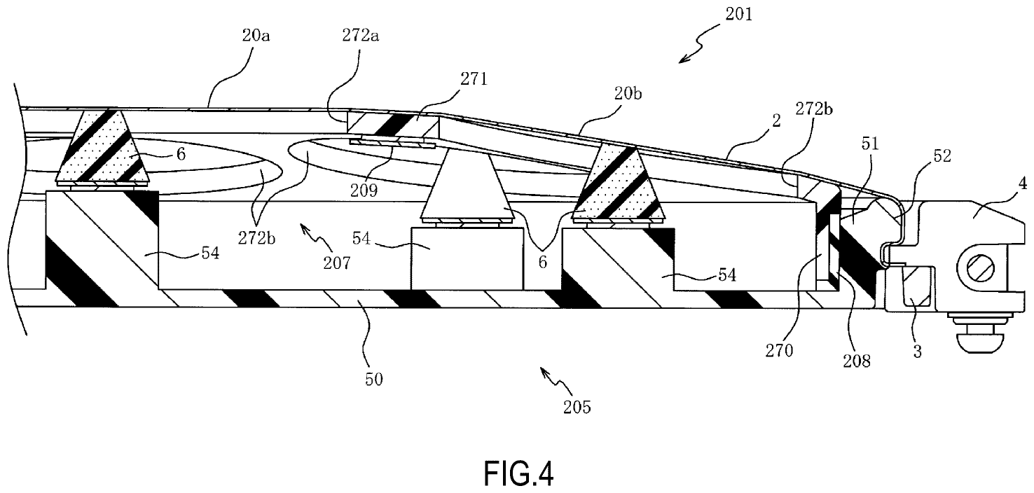

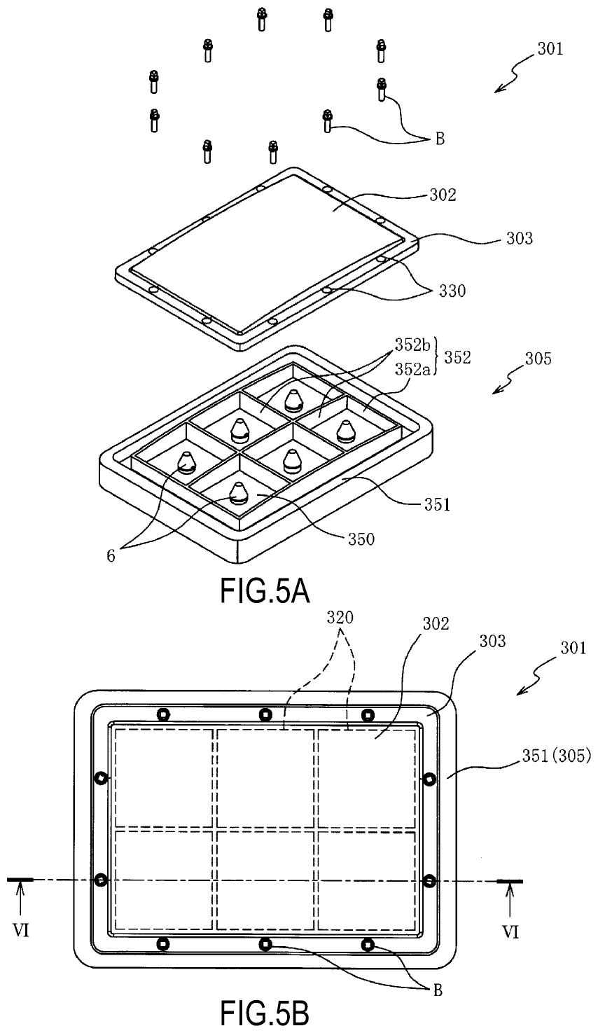

Here, in this embodiment, the hitting surfaces 20a, 20b are divided by the partition parts 53a, 53b rising upward from the bottom part 50 of the body part 5, but for example, as in a second embodiment (see FIGS. 3 and 4) to be described later, the plurality of hitting surfaces 20a, 20b may be formed by a partition part 271 bridging over the wall part 51 of a body part 205. However, in the case of such a configuration, depending on the rigidity of the partition part 271 (strength of the hit), the partition part 271 may be deformed by bending downward due to the hit, and the film part 2 may flap. If such flapping of the film part 2 occurs, there is a risk that the hit sensor 6, which is at a position away from the hit position, will erroneously detect the hit.

In view of this, in this embodiment, the partition parts 53a, 53b protrude upward from the bottom part 50 of the body part 5, it is possible to suppress deformation of the partition parts 53a, 53b even if a hit is made directly above the partition parts 53a, 53b. Consequently, it is possible to suppress the flapping of the film part 2 as described above, and therefore it is possible to suppress the hit sensor 6 in contact with the other hitting surfaces 20b from erroneously detecting the vibration, for example, when the hitting surface 20a is hit. In other words, it is possible to suppress the hit sensor 6 at a position away from the hit position from erroneously detecting the hit.

Further, the flapping of the film part 2 as described above is likely to occur when a pressing force (close adherence) of the film part 2 against each of the partition parts 53a, 53b is insufficient. In view of this, in this embodiment, the height of the partition part 53a from the bottom part 50 of the body part 5 is constant over the entire circumference of the partition part 53a, while the height of the partition part 53b gradually decreases toward the outer peripheral side. In other words, the upper end of the partition part 53b is inclined downward at a constant gradient toward an outer edge side of the film part 2, such that the film part 2 may be formed into a shape close to a dome (hemisphere).

Consequently, it is easier for the upper end of each of the partition parts 53a, 53b to closely adhere to the film part 2 when tension is applied to the film part 2, thereby suppressing the film part 2 from flapping as described above. Thus, it is possible to suppress the hit sensor 6 at a position away from the hit position from erroneously detecting a hit. Further, by forming the film part 2 into a shape close to a dome, the hitting surfaces of a handpan may be simulated by the film part 2. A handpan is a metal idiophone, and is a steelpan that is played by striking a plurality of hitting surfaces formed on a dome-shaped upper surface with bare hands.

The partition parts 53a, 53b are each formed in a cylindrical shape. The partition part 53a is disposed in a region including the center (axis) of the film part 2, and the partition part 53a is surrounded by a plurality of partition parts 53b (eight in this embodiment) that are arranged at equal intervals in the circumferential direction. Thus, the circular hitting surface 20a is formed in the center of the film part 2, and a plurality of circular hitting surfaces 20b are arranged at equal intervals in the circumferential direction on the outer peripheral side of the hitting surface 20a. Consequently, it is possible to form the hitting surfaces 20a, 20b simulating a handpan on the film part 2.

The inner diameters of the plurality of partition parts 53b are the same, and the inner diameter of the partition part 53a is formed to larger than the inner diameter of the partition parts 53b. Thus, the areas of the plurality of hitting surfaces 20b arranged in the circumferential direction are the same, while the area of the hitting surface 20a is formed to be larger than those of the hitting surfaces 20b. Consequently, it is also possible to form the hitting surfaces 20a, 20b that simulate a handpan on the film part 2.

Moreover, since the hitting surface 20a positioned at the center of the film part 2, i.e., the hitting surface 20a that is hit more frequently, is formed relatively large, it is possible to suppress the possibility of mistakenly striking the hitting surfaces 20a and 20b. Thus, it is easier for the performer to play the performance (generate musical tones) as intended.

In this way, when the area of the hitting surface 20a is formed relatively large, the amplitude of the film part 2 caused by the hit may easily increase, and therefore the flapping of the film part 2 at the time of hitting as described above is likely to occur when the hitting surface 20a is hit. Thus, in this embodiment, the spacing (dimension of separation) between the hitting surface 20a and the hitting surfaces 20b are set to be larger than the spacing between the hitting surfaces 20b. Thereby, the hitting surface 20a where the film part 2 is likely to flap may be disposed at a position away from the other hitting surfaces 20b. Consequently, it is possible to suppress the hit sensor 6 in contact with the other hitting surfaces 20b from erroneously detecting the vibration generated when the hitting surface 20a is hit.

The film part 2 is formed using a net-like material (a mesh woven from synthetic fibers) and is more slippery and flexible than, for example, a rubber pad. Consequently, it is possible to improve the slippage when hitting the hitting surfaces 20a, 20b, and to improve the detection sensitivity of the hit sensor 6 for weak hits on the hitting surfaces 20a, 20b. Thus, for example, playing (hitting) by sliding the hand over the hitting surfaces 20a, 20b becomes easier, and such playing by sliding the hand (stroking) becomes easier to detect by the hit sensor 6. Thus, it is possible to suitably play a performance that simulates a handpan.

Moreover, since the film part 2 is formed using a net-like material, by identifying the partition parts 53a, 53b that are visible through the film part 2 or recognizing the shapes of the partition parts 53a, 53b that fit into the film part 2, the player can easily recognize in which regions the hitting surfaces 20a, 20b are formed (where to hit to produce a musical tone).

Further, since the film part 2 is formed using a net-like material, when hitting the hitting surfaces 20a, 20b on the inner periphery side of the partition parts 53a, 53b, a comparatively soft hitting feel is obtained, while when hitting directly above the partition parts 53a, 53b, a hard hitting feeling is obtained. The difference in hitting feel also makes it possible to easily recognize in which regions the hitting surfaces 20a, 20b are formed.

Here, when a hit is made directly above the partition parts 53a, 53b, the vibration may be transmitted via the bottom part 50 of the body part 5 to the partition parts 53a, 53b in other regions. Thus, for example, when the hitting surface 20a is hit, the hit sensor 6 in contact with the other hitting surfaces 20b may erroneously detect the hit.

In view of this, in this embodiment, the partition parts 53a, 53b are formed in a plate shape (cylindrical shape) rising upward from the bottom part 50, such that the contact area between the hitting surfaces 20a, 20b and the partition parts 53a, 53b can be reduced. Consequently, compared to a case in where the partition part 271 is in planar contact with the film part 2 as in a second embodiment described below (see FIGS. 3 and 4), it is more difficult to hit directly above the partition parts 53a, 53b. Thereby, it is possible to suppress the hit sensor 6 at a position away from the hit position from erroneously detecting a hit.

Further, in this embodiment, since each of the partition parts 53a, 53b is separated from each other, even if, for example, even if a hit is made directly above the partition part 53a, it is possible to suppress the vibration from being transmitted to the other partition parts 53b. Further, even if a region between each of the partition parts 53a, 53b (a region where no hit sensor 6 is present) is hit, it is possible to suppress the hit sensor 6 from erroneously detecting the hit. In other words, by separating each of the partition parts 53a, 53b from each other, it is possible to suppress the hit sensor 6 at a position away from the hit position from erroneously detecting a hit.

Next, an electronic percussion instrument 201 according to a second embodiment will be described with reference to FIGS. 3 and 4. In the first embodiment, a case has been described in which the hitting surfaces 20a, 20b are divided by the partition parts 53a, 53b protruding from the bottom part 50 of the body part 5, but in the second embodiment, a case will be described in which the hitting surfaces 20a, 20b are divided by the partition member 207 (partition part 271) to be attached to the body part 205. Moreover, the same parts as those in the first embodiment described above are given the same reference numerals and the description thereof will be omitted. FIG. 3 is an exploded perspective view of the electronic percussion instrument 201 according to the second embodiment, and FIG. 4 is a partially enlarged cross-sectional view of the electronic percussion instrument 201 taken along line IV-IV in FIG. 3.

As shown in FIG. 3, the electronic percussion instrument 201 of the second embodiment includes the partition member 207 to be attached to the body part 205. The body part 205 has the same configuration as the body part 5 of the first embodiment, except that the partition parts 53a, 53b (see FIG. 1) are not formed.

The partition member 207 includes an annular (cylindrical) outer periphery part 270 and the partition part 271 connected to the upper end of the outer periphery part 270, and these parts are integrally formed using a resin material. The outer diameter of the outer periphery part 270 is formed to be the same as (or slightly smaller than) the inner diameter of the wall part 51, and the partition member 207 is fixed to the body part 205 by fitting the outer periphery part 270 into the inner periphery side of the wall part 51. The outer periphery part 270 of the partition member 207 may be adhered to the bottom part 50 or the wall part 51, or may simply be fitted thereto.

The partition part 271 is formed such that its overall shape is disk-like, and a through hole 272a is formed in a region including the center (axis) of the partition part 271, and the through hole 272a is surrounded by a plurality of through holes 272b. Each of the through holes 272a, 272b is formed in a circular shape, and the plurality of through holes 272b are arranged at equal intervals in the circumferential direction. In other words, the through holes 272a, 272b are formed to have a size and arrangement corresponding to the partition parts 53a, 53b of the first embodiment. Thus, when tension is applied to the film part 2, the hitting surfaces 20a, 20b (see FIG. 4) similar to those in the first embodiment are formed on the film part 2. Consequently, similarly to the first embodiment, various performances become possible using the plurality of hitting surfaces 20a, 20b, and the electronic percussion instrument 201 may be formed with hitting surfaces that simulate a handpan.

As shown in FIG. 4, in a region positioned between the through hole 272a and the through hole 272b in the radial direction, an upper surface of the partition part 271 is formed in a planar shape perpendicular to the up-down direction, while in the region where the through hole 272b is formed in the radial direction, the upper surface of the partition part 271 slopes downward (at a constant gradient) toward the outer edge side of the film part 2. Consequently, it is possible to form the shape of the film part 2 into a dome (hemisphere), such that the film part 2 may be formed into a shape that simulates a handpan and the close adherence between the film part 2 and the partition part 271 can be improved.

The partition part 271 is connected to the body part 205 (the bottom part 50 supporting the hit sensor 6) via the outer periphery part 270 of the partition member 207, even if a hit is made directly above the partition part 271, it is possible to suppress the hit sensor 6 from erroneously detecting the hit.

A vibration-proof material 208 made of rubber or sponge (elastic material) is attached to an outer edge of the partition member 207. The vibration-proof material 208 is formed in an annular shape with an L-shaped cross-section, and an outer peripheral surface and a lower surface of the outer periphery part 270 are covered by the vibration-proof material 208 over the entire circumference. Consequently, the vibration generated when a hit is made directly above the partition part 271 can be damped by the vibration-proof material 208, thereby suppressing the hit sensor 6 from erroneously detecting the hit.

Moreover, a sensor 209 is adhered to a lower surface of the partition part 271. The sensor 209 is a disk-shaped piezoelectric element, and is configured to cancel the generation of musical tones when a vibration is detected by the sensor 209. Consequently, even if vibration when a hit is made directly above the partition part 271 are transmitted to the hit sensor 6, it is possible to suppress musical tones from being generated by the vibration.

Moreover, in this embodiment, the generation of musical tones is cancelled when vibration is detected by the sensor 209, but the present invention is not necessarily limited thereto. For example, when vibration is detected by the sensor 209, a musical tone different from that generated when vibration is detected by the hit sensor 6 may be generated.

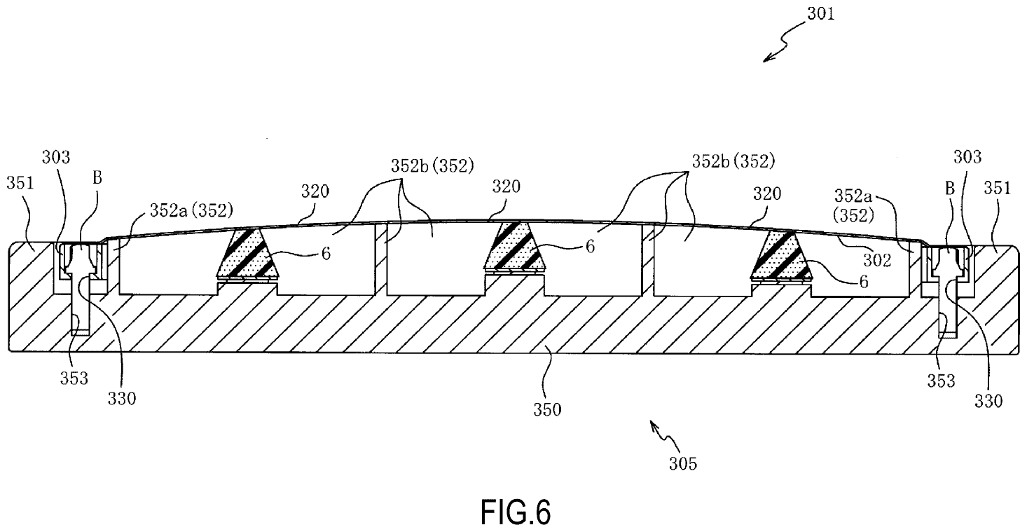

Next, an electronic percussion instrument 301 according to a third embodiment will be described with reference to FIGS. 5 and 6. In the first and second embodiments, a case has been described in which the film part 2 is circular, but in the third embodiment, the case where a film part 302 is formed in a rectangular shaped will be described. Moreover, the same parts as those in the first embodiments described above are given the same reference numerals and the description thereof will be omitted.

FIG. 5(a) is an exploded perspective view of the electronic percussion instrument 301 according to the third embodiment, and FIG. 5(b) is a top view of the electronic percussion instrument 301. FIG. 6 is a cross-sectional view of the electronic percussion instrument 301 taken along line VI-VI in FIG. 5(b). In FIG. 5(b), regions of hitting surfaces 320 divided by a partition part 352 are indicated by dashed lines.

As shown in FIGS. 5 and 6, the film part 302 of the electronic percussion instrument 301 of the third embodiment is formed by forming the film part 2 of the first embodiment into a rectangular (oblong) shape. A square ring-shaped frame part 303 is joined to an outer edge of the film part 302, and the frame part 303 has through holes 330 formed at a plurality of locations (10 locations in this embodiment) in the circumferential direction. The through hole 330 is a hole for inserting a bolt B that fixes the frame part 303 to a body part 305.

The body part 305 includes a bottom part 350 formed in a rectangular plate shape, and a square ring-shaped (square tubular) wall part 351 rising upward from an outer edge of the bottom part 350. The body part 305 is formed with the wall-like partition part 352 rising upward from the bottom part 350.

The partition part 352 includes an outer peripheral wall 352a that surround a plurality of hit sensors 6 in a rectangular shape, and a divider wall 352b that divides the outer peripheral wall 352a into a lattice shape. Between the outer peripheral wall 352a and the wall part 351, a female threaded hole 353 (see FIG. 6) for screwing in the bolt B is formed in the bottom part 350. A plurality of female threaded holes 353 are formed at positions corresponding to the through holes 330 of the frame part 303. Thus, with the frame part 303 disposed between the wall part 351 and the outer peripheral wall 352a (with the film part 302 hooked onto the outer peripheral wall 352a), tension is applied to the film part 302 by screwing the bolt B inserted into the through hole 330 into the female threaded hole 353.

When tension is applied to the film part 302, each of the walls 352a, 352b of the partition part 352 are in contact with the film part 302. Thus, the film part 302 is formed with the plurality of hitting surfaces 320 that are divided by the partition part 352.

The plurality of regions (six in this embodiment) surrounded by the outer peripheral wall 352a and the divider wall 352b all have the same size. Thus, the areas of the plurality of hitting surfaces 320 formed on the film part 302 are all the same.

Since the hit sensor 6 is provided in each of the regions surrounded by the outer peripheral wall 352a and the divider wall 352b, vibration of a hit against each of the hitting surfaces 320 may be detected by the hit sensors 6. Consequently, various performances become possible, for example, by generating musical tones with different timbres according to the hitting surface 320 that is hit.

Since each of the hit sensors 6 is partitioned by one single divider wall 352b, for example, compared to the case of the first embodiment in which the partition parts 53a, 53b are separated from each other (hit sensors 6 are partitioned by a plurality of walls), the structure of the body part 305 can be simplified.

An upper end of the partition part 352 is inclined downward toward an outer edge side of the film part 302. in particular, the height of each of the walls 352a, 352b from the bottom part 350 of the body part 305 is constant in the short side direction of the film part 302 (perpendicular to the paper surface in FIG. 6), while in the long side direction of the film part 302 (left-right direction in FIG. 6), the height of each of the walls 352a, 352b of the partition part 352 increases toward the center. In other words, the upper end of each of the walls 352a, 352b is formed in an upwardly convex arc shape, such that it is easier for the upper end of each of the walls 352a, 352b (partition part 352) to closely adhere to the film part 302 when tension is applied to the film part 302. Thus, it is possible to suppress the hit sensor 6 at a position away from the hit position from erroneously detecting a hit.

The description has been made based on the above embodiments, but the present invention is not limited to the above embodiments, and it can be easily inferred that various improvements and modifications are possible within the scope that does not deviate from the spirit of the present invention.

In each of the above embodiments, a case has been described in which the electronic percussion instruments 1 and 201 are circular, or the electronic percussion instrument 301 is rectangular, but the present invention is not necessarily limited thereto. For example, the electronic percussion instruments 1 and 201 may be formed in a rectangular or other polygonal shape, and the electronic percussion instrument 301 may be formed in a circular or polygonal shape other than a rectangle.

In each of the above embodiments, a case has been described in which the film parts 2, 302 are net-like, but the present invention is not necessarily limited thereto. For example, the film parts 2, 302 may be formed using other known materials such as a synthetic resin film.

In each of the above embodiments, a case has been described in which the film parts 2, 302 are formed into a dome shape by covering the partition parts 53a, 53b, 352 (which slope downward toward the outer peripheral side) with the (flat) film parts 2, 302, which are formed into a disk shape using a net-like material, but the present invention is not necessarily limited thereto. For example, a configuration may also be adopted in which the film parts 2, 302 is formed in advance into an upwardly convex arc shape by thermoforming or the like. In this case, it is preferable to make the curvature of the upper ends of the partition parts 53a, 53b, and 352 larger than the curvature of the film parts 2, 302. Consequently, it is easier for the upper ends of the partition parts 53a, 53b, 352 to closely adhere to with the film part 2 when tension is applied to the film parts 2, 302. Moreover, the curvature of the upper ends of the partition parts 53a, 53b refers to the curvature of a curved surface including (along the upper ends) the upper end of each of the partition parts 53a, 53b.

In each of the above embodiments, a case has been described in which the hit sensor 6 is a contact type sensor, or the sensor 61 constituting the hit sensor 6 is a piezoelectric element, but the present invention is not necessarily limited thereto. For example, the hit sensor 6 may use a non-contact type detection element, or a contact type detection element such as an electrodynamic type, a capacitance type, or a pressure-sensitive resistive type.

In each of the above embodiments, as an example of a tension applying part for applying tension to the film parts 2, 302, the tension ring 4 for tightening the frame part 3 or the bolt B screwed into the frame part 303 have been given, but the present invention is not necessarily limited thereto. For example, a configuration may also be adopted in which tension is applied to the film parts 2, 302 by hooking an annular hoop onto the frame parts 3, 303 like a typical drum, and screwing the hoop to the body parts 5, 205, 305 (pulling it toward the body part).

In each of the above embodiments, a case has been described in which a lower surface side of the body parts 5, 205, 305 is closed by the bottom parts 50, 350, but the present invention is not necessarily limited thereto. For example, a configuration may be adopted in which a part of the bottom parts 50, 350 has an opening. In other words, the bottom parts 50, 350 only need to be configured to be able to support at least the hit sensor 6.

In the first and second embodiments, a case has been described in which the height of the partition parts 53b or the height of the partition part 271 in the range in which through holes 272b are formed gradually decreases (at a constant gradient) toward the outer peripheral side, the present invention is not necessarily limited thereto. For example, the upper end of partition parts 53b or the upper surface of the partition part 271 in the range where the through holes 272b are formed may be formed in a curved shape (an upwardly convex arc shape) that slopes downward toward the outer peripheral side, or the height of the partition parts 53b and the partition part 271 may be constant.

In the above first and second embodiments, a case has been described in which the hitting surface 20a is formed in the center of the film part 2, and the hitting surface 20a is surrounded by the plurality of hitting surfaces 20b arranged at equal intervals in the circumferential direction, but the present invention is not necessarily limited thereto. For example, a configuration may also be adopted in which the hitting surface 20a or some of the hitting surfaces 20b is omitted, or the hitting surfaces 20b are arranged at irregular intervals in the circumferential direction. In other words, the number and arrangement of the plurality of hitting surfaces 20a, 20b may be set appropriately.

In the above first and second embodiments, a case has been described in which the hitting surfaces 20a, 20b are formed in a circular shape, and the hitting surface 20a has a larger area than the hitting surfaces 20b, but the present invention is not necessarily limited thereto. For example, either or both of the hitting surfaces 20a, 20b may be formed in a polygonal shape. A configuration may also be adopted in which the areas of the hitting surfaces 20a, 20b are all the same, or the areas of the hitting surfaces 20b are larger than that of the hitting surface 20a. In other words, the shapes and area sizes of the plurality of hitting surfaces 20a, 20b may be set appropriately.

In the above first and third embodiments, a case has been described in which the partition parts 53a, 53b, 352 are formed integrally with the body parts 5, 305, but the present invention is not necessarily limited thereto. For example, a configuration may be adopted in which a partition member (formed separately from the body parts 5, 305) including the partition parts 53a, 53b, 352 is fixed to the body parts 5, 305.

In the above first embodiment, a case has been described in which the cylindrical partition parts 53a, 53b are separated from each other, but the present invention is not necessarily limited thereto. For example, a configuration may also be adopted in which the partition parts 53a, 53b are formed in a lattice shape like the partition part 352 of the third embodiment, or the partition parts 53a, 53b are in contact with each other (partially formed integrally).

In the above second embodiment, a case has been described in which the vibration-proof material 208 is attached to an outer edge side of the partition member 207 or the sensor 209 is attached to the lower surface of the partition part 271, but the vibration-proof material 208 or the sensor 209 may be omitted.

Further, a configuration equivalent to the vibration-proof material 208 or the sensor 209 may be applied to the electronic percussion instrument 1 of the first embodiment. In other words, a configuration may also be adopted in which, for example, a vibration-proof material made of rubber or sponge (elastic material) is fitted between the partition parts 53a, 53b of the first embodiment, such that the free vibration of the partition parts 53a, 53b is restricted by the vibration-proof material and the vibration transmitted between the partition parts 53a, 53b is damped by the vibration-proof material.

Moreover, a configuration may also be adopted in which the sensor 209 is adhered to the bottom part 50 positioned between the partition parts 53a, 53b of the first embodiment (or directly to the partition parts 53a, 53b), and generation of musical tones is canceled when vibration is detected by the sensor 209.

In the above third embodiment, a case has been described in which the upper end of each of the walls 352a, 352b extending in the long side direction of the film part 302 is formed in an upwardly convex arc shape, but the present invention is not necessarily limited thereto. For example, a configuration may also be adopted in which in the short side or long side directions of the film part 302, the height of each of the walls 352a, 352b decreases at a constant gradient toward the outer peripheral side, or a configuration may also be adopted in which the height of all the walls 352a, 352b are constant. Further, the upper end of each of the walls 352a, 352b extending in the short side direction of the film part 302 may be formed in an upwardly convex arc shape.

In the third embodiment, a case has been described in which the hit sensors 6 are partitioned by one single divider wall 352b, but the present invention is not necessarily limited thereto. For example, a configuration may also be adopted in which, as in the first embodiment, the hit sensors 6 are partitioned by a plurality of divider walls 352b.

In the third embodiment, a case has been described in which the rectangular hitting surfaces 320 each have the same area, but the present invention is not necessarily limited thereto. For example, some or all of the plurality of hitting surfaces 320 may be formed in a circular or other polygonal shape. Further, a configuration may also be adopted in which the areas of the plurality of hitting surfaces 320 are all the same, or some of the hitting surfaces 320 have areas larger than the other hitting surfaces 320. In other words, the shapes or areas of the plurality of 320 may be set appropriately.

### REFERENCE SIGNS LIST

1, 201, 301 Electronic percussion instrument
2, 302 Film part
20a Hitting surface (central hitting surface)
20b Hitting surface (peripheral hitting surface)
320 Hitting surface
4 Tension ring (tension applying part)
5, 205, 305 Body part
50, 350 Bottom part
6 Hit sensor
53a, 53b, 271, 352 Partition part
B Bolt (tension applying part)

To the claims:

1. An electronic percussion instrument, comprising:
a body part;
a film part, covering an upper surface side of the body part;
a tension applying part, applying tension to the film part;
a partition part, contacting a lower surface of the film part to which tension is applied by the tension applying part and partitioning the film part into a plurality of hitting surfaces; and
a plurality of hit sensors, detecting a hit against each of the plurality of hitting surfaces formed by the partition part.

2. The electronic percussion instrument according to claim 1, wherein
an upper end of the partition part is inclined downward toward an outer edge side of the film part.

3. The electronic percussion instrument according to claim 1, wherein
the body part comprises a bottom part that supports the hit sensors, and
the partition part protrudes upward from the bottom part.

4. The electronic percussion instrument according to claim 3, wherein
the partition part is formed in a plate shape.

5. The electronic percussion instrument according to claim 3, wherein
a plurality of the partition parts are spaced apart from one another.

6. The electronic percussion instrument according to claim 1, wherein
the film part is formed in a circular shape, and
the hitting surface is composed of at least a central hitting surface formed in a region including a center of the film part, and a plurality of peripheral hitting surfaces surrounding the central hitting surface in a circumferential direction of the film part.

7. The electronic percussion instrument according to claim 6, wherein
the central hitting surface is formed to have an area larger than those of the peripheral hitting surfaces.

8. The electronic percussion instrument according to claim 6, wherein
the film part is formed using a net-like material.

9. A hit detection method for an electronic percussion instrument, wherein the electronic percussion instrument comprises:
a body part;
a film part, covering an upper surface side of the body part;
a tension applying part, applying tension to the film part; and
a partition part, contacting a lower surface of the film part to which tension is applied by the tension applying part and partitioning the film part into a plurality of hitting surfaces,
wherein the hit detection method comprises:
detecting a hit against each of the plurality of hitting surfaces formed by the partition part by a plurality of hit sensors.

10. The hit detection method according to claim 9, wherein
an upper end of the partition part is inclined downward toward an outer edge side of the film part.

11. The hit detection method according to claim 9, wherein
the body part comprises a bottom part that supports the hit sensors, and
the partition part protrudes upward from the bottom part.

12. The hit detection method according to claim 11, wherein
the partition part is formed in a plate shape.

13. The hit detection method according to claim 11, wherein
a plurality of the partition parts are spaced apart from one another.

14. The hit detection method according to claim 9, wherein
the film part is formed in a circular shape, and
the hitting surface is composed of at least a central hitting surface formed in a region including a center of the film part, and a plurality of peripheral hitting surfaces surrounding the central hitting surface in a circumferential direction of the film part.

15. The hit detection method according to claim 14, wherein
the central hitting surface is formed to have an area larger than those of the peripheral hitting surfaces.

16. The hit detection method according to claim 14, wherein
the film part is formed using a net-like material.

17. A manufacturing method of an electronic percussion instrument, comprising:
providing a body part;
providing a film part, covering an upper surface side of the body part;
providing a tension applying part, applying tension to the film part;
providing a partition part, contacting a lower surface of the film part to which tension is applied by the tension applying part and partitioning the film part into a plurality of hitting surfaces; and
providing a plurality of hit sensors, detecting a hit against each of the plurality of hitting surfaces formed by the partition part.

18. The manufacturing method according to claim 17, wherein
an upper end of the partition part is inclined downward toward an outer edge side of the film part.

19. The manufacturing method according to claim 17, wherein
the body part comprises a bottom part that supports the hit sensors, and
the partition part protrudes upward from the bottom part.

20. The manufacturing method according to claim 17, wherein
the film part is formed in a circular shape, and
the hitting surface is composed of at least a central hitting surface formed in a region including a center of the film part, and a plurality of peripheral hitting surfaces surrounding the central hitting surface in a circumferential direction of the film part.
